(19) United States
(12) Patent Application Publication
(10) Pub. No.: US 2009/0256998 A1
(43) Pub. Date: Oct. 15, 2009

(54) BACKLIGHT MODULE AND LIQUID CRYSTAL DISPLAY

(76) Inventors: Haiyu ZHAO, Beijing (CN); Xinyuan YANG, Beijing (CN)

Correspondence Address: LADAS & PARRY LLP, 224 SOUTH MICHIGAN AVENUE, SUITE 1600, CHICAGO, IL, 60604, US

(21) Appl. No.: 12/417,805

(22) Filed: Apr. 3, 2009

(30) Foreign Application Priority Data
Apr. 10, 2008 (CN) 200820079869.X

(51) Int. Cl. G02F 1/13357

(52) U.S. Cl. 349/64

(57) ABSTRACT

A backlight module and a liquid crystal display are provided. The liquid crystal display comprises a liquid crystal panel, a light source provided below the liquid crystal panel and at least one support member provided on the upper surface of the light source for supporting a liquid crystal panel. According to the embodiment of the present invention, when the liquid crystal panel is subject to a force upon pressing or impact, the force can be counteracted by the support member. Therefore, the deformation of the liquid crystal panel can be effectively reduced so that light leakage can be prevented.

### BACKGROUND

Embodiments of the present invention relate to a backlight module and a liquid crystal display.

Liquid crystal display devices (LCDs) are widely used in electronic apparatus such as a notebook-size personal computer, a mobile phone, an MP3 and the like due to the advantages such as low radiation, low power consumption, light weight, thin profile, and high display quality. A LCD typically includes a liquid crystal panel, a backlight module, and so on. FIG. 1 is a schematic view illustrating a conventional structure of a LCD. As shown in FIG. 1, the backlight module includes a light source 8. The light source 8 is affixed onto a frame 6. The liquid crystal panel 5 is provided on the frame 6 so that the light source 8 and the liquid crystal panel 5 can be assembled together. One or more than one optical films may be provided on the surface of the light source. The optical films may comprise a prism film 2 and a protection film 1 provided on the prism film 2 for protecting the prism film 2.

FIG. 2 is a schematic view showing a conventional construction for preventing light leakage. As shown in FIG. 2, the structure of the frame 6 of the backlight module is modified with a PET plate 7 provided on the upper surface of the liquid crystal panel 5 and another PET plate 7 provided between the lower surface of the liquid crystal panel 5 and the upper surface of the optical film 4.

### SUMMARY

According to one aspect of the present invention, a backlight module comprises a light source. At least one support member formed on an upper portion of an optical film is provided on the upper surface of the light source for supporting a liquid crystal panel.

Preferably, the support member may have a cross-section selected from the group consisting of an arc-shaped body with a higher central portion and two lower ends, a column body and a trapezoid-like body. The optical film composing the support member may be a prism film, a protection film, or a diffusing film.

According to another aspect of the present invention, there is provided a liquid crystal display device comprising a liquid crystal panel, a light source provided below the liquid crystal panel, and at least one support member formed on an upper portion of an optical film provided on the upper surface of the light source for supporting the liquid crystal panel.

According to the embodiments of the present invention, when the liquid crystal panel is subject to a force upon pressing or impact, the force can be counteracted by the support member. Therefore, the deformation of the liquid crystal panel can be effectively reduced so that light leakage can be prevented and the display quality of the liquid crystal panel can be improved.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from the following detailed description.

### BRIEF DESCRIPTION OF THE DRAWINGS

The present invention will become more fully understood from the detailed description given hereinafter and the accompanying drawings which are given by way of illustration only, and thus are not limitative of the present invention and wherein:

FIG. 1 is a conventional schematic view showing a liquid crystal display device;

FIG. 2 is a schematic view showing a conventional solution for preventing light leakage;

FIG. 3 is a schematic view showing a structure of a backlight module according to a first embodiment of the present invention;

FIG. 4 a schematic view showing the structure of the backlight module according to a second embodiment of the present invention;

FIG. 5 is a schematic view showing the structure of the backlight module according to a third embodiment of the present invention;

FIG. 6 is a schematic view showing the structure of the backlight module according to a fourth embodiment of the present invention;

FIG. 7 is a schematic view showing the structure of the backlight module according to a fifth embodiment of the present invention; and

FIG. 8 is a schematic view showing the structure of the backlight module according to a sixth embodiment of the present invention.

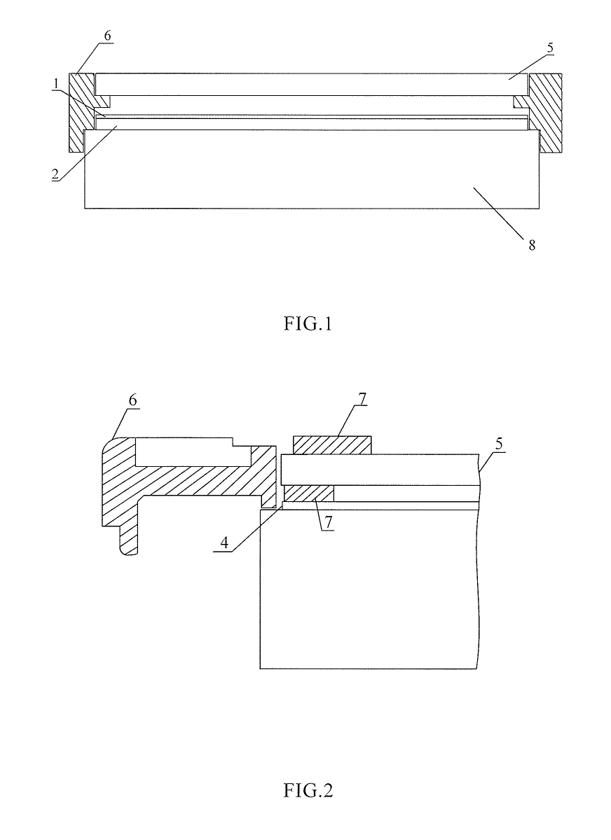

### DETAILED DESCRIPTION OF THE EMBODIMENTS

### First Embodiment

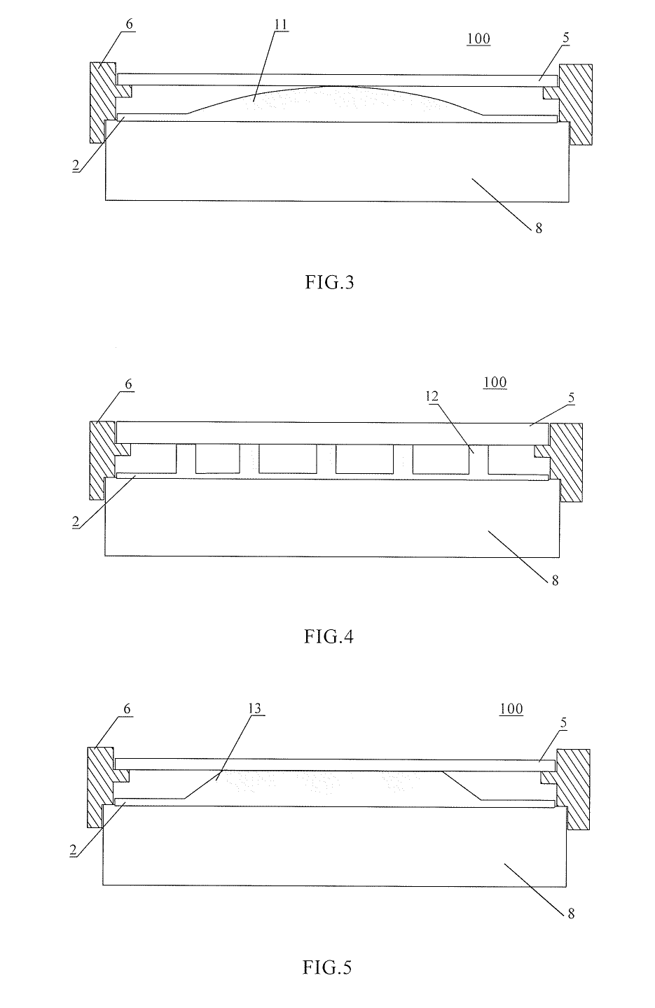

FIG. 3 is a schematic view showing the structure of a backlight module according to a first embodiment of the present invention. As shown in FIG. 3, the backlight module 100 may comprise a light source 8 with a prism film 2 provided on the surface of the light source 8. Particularly, the prism film 2 includes a support member 11, as an upper portion, having an arc shape with a higher central portion and two lower ends. That is, the support member 11 has a cross section shape of a closed shape with a top bending line. The gap between the highest point of the support member 11 and a liquid crystal panel 5 provided on a frame 6 is small so as to be capable of supporting the liquid crystal panel 5 provided on the frame 6, thus light leakage can be prevented when a deformation occurs in the liquid crystal panel. In the embodiment, the number of the support member of the prism film 2 can be one, such as shown in FIG. 3. Alternatively, the number of the support member 11 can be more than one. In addition, other optical films can also be provided above the prism film, such as a protection film for protecting the prism film, a diffusing film for improving the optical efficiency, etc., depending on design requirements. The positions and the number of those optical films can be adjusted as necessary.

According to the present embodiment, at least one arc-shaped support member is provided on the surface of the prism film 2 for supporting the liquid crystal panel that is deformed. When the liquid crystal panel is subject to a force upon pressing or impact, the force can be counteracted by the support member provided on the prism film. Therefore, the deformation of the liquid crystal panel can be effectively reduced so that light leakage can be prevented.

The relationship of the gap between the liquid crystal panel and the support member and the level of light leakage is shown in the following Table I. As shown in Table I, the level of light leakage of the liquid crystal panel is decreased with the reduction of the gap between the liquid crystal panel and the support member.

TABLE I

| gap | light leakage level |
|---|---|
| 1.07 mm | level 6 |
| 0.5 mm | level 5~level 6 |
| 0.2 mm | level 3~level 4 |
| 0.1 mm | level 2~level 3 |

### Second Embodiment

FIG. 4 is a schematic view showing the structure of a backlight module according to a second embodiment of the present invention. As shown in FIG. 4, the backlight module 100 may comprise a light source 8 with a prism film 2 provided on the surface of the light source 8. A support member 12 having a columnar shape is provided on the upper surface of the prism film 2 as an upper portion. When the liquid crystal panel 5 is subject to a force upon pressing or impact, the force can be counteracted by the support member. Therefore, the deformation of the liquid crystal panel 5 provided on the frame 6 can be effectively reduced so that light leakage can be prevented. In the embodiment, the number of the support member 11 can be more than one, such as shown in FIG. 4. Alternatively, the number of support member 11 can be one. In addition, other optical films can also be provided above the prism film, such as a protection film for protecting the prism film, a diffusing film for improving the optical efficiency, etc., depending on design requirements. The positions and the number of those optical films can be adjusted as necessary.

According to the present embodiment, at least one columnar support member is provided on the surface of the prism film for supporting the liquid crystal panel. When the liquid crystal panel is subject to a force upon pressing or impact, the force can be counteracted by the columnar support member provided on the prism film, and therefore the deformation of the liquid crystal panel can be effectively reduced to prevent light leakage.

### Third Embodiment

FIG. 5 is a schematic view showing the structure of the backlight module according to a third embodiment of the present invention. As shown in FIG. 5, the backlight module 100 may comprise a light source 8 with a prism film 2 provided on the surface of the light source 8. A support member 13 having a trapezoid-like shape with a trapezoid-like cross section is provided on the upper surface of the prism film 2, as an upper portion, for supporting the liquid crystal panel 5. When the liquid crystal panel 5 is subject to a force upon pressing or impact, the force can be counteracted by the support member. Therefore, the deformation of the liquid crystal panel 5 provided on the frame 6 can be effectively reduced so that light leakage can be prevented. In the embodiment, the number of the support member can be one, as shown in FIG. 5. Alternatively, the number of the support member can be more than one. In addition, other optical films can also be provided above the prism film, such as a protection film for protecting the prism film, a diffusing film for improving the optical efficiency, etc., depending on design requirements. The positions and the number of those optical films can be adjusted as necessary.

### Fourth Embodiment

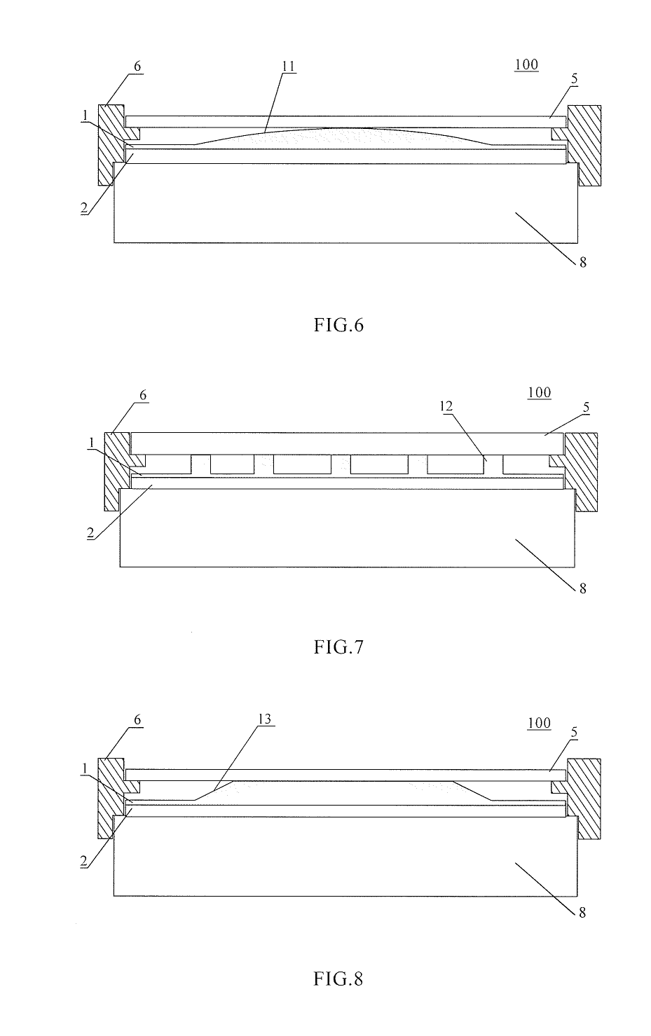

FIG. 6 is a schematic view showing the structure of the backlight module according to a fourth embodiment of the present invention. As shown in FIG. 6, the backlight module 100 may comprise a light source 8 with a prism film 2 and a protection film 1 provided on the surface of the light source 8. The protection film 1 is provided on the upper surface of the prism film 2. A support member 11 having an arc shape with a higher central portion and two lower ends is provided on the protection film 1 as an upper portion. That is, the support member 11 has a cross section shape of a closed shape with a top bending line. The gap between the highest point of the support member 11 and a liquid crystal panel 5 provided on a frame 6 is small so as to be capable of supporting the liquid crystal panel 5 provided on the frame 6, thus light leakage can be prevented when a deformation occurs in the liquid crystal panel. In the embodiment, the number of the support member can be one, such as shown in FIG. 6. Alternatively, the number of the support member can be more than one. In addition, other optical films can also be provided above the prism film, such as a protection film for protecting the prism film, a diffusing film for improving the optical efficiency, etc., depending on design requirements. The positions and the number of those optical films can be adjusted as necessary.

According to the embodiment, the protection film 1 is provided on the prism film 2 and at least one arc-shaped support member is provided on the surface of the protection film for supporting the liquid crystal panel. When the liquid crystal panel is subject to a force upon pressing or impact, the force can be counteracted by the arc support member provided on the protection film. Therefore, the deformation of the liquid crystal panel can be effectively reduced so that light leakage can be prevented.

In the embodiment, for example, the area occupied by the support member may be about ⅙˜½ of that of the liquid crystal panel, which can be varied according to the gap between the liquid crystal panel and the light source. The area occupied by the support member may be decreased with the reduction of the gap and vice versa.

### Fifth Embodiment

FIG. 7 is a schematic view showing the structure of the backlight module according to a fifth embodiment of the present invention. As shown in FIG. 7, the backlight module 100 may comprise a light source 8 with a prism film 2 and a protection film 1 provided on the surface of the light source 8. The protection film 1 is provided on the upper surface of the prism film 2. A support member 12 having a columnar shape is provided on the protection film 1 as an upper portion. When the liquid crystal panel 5 is subject to a force upon pressing or impact, the force can be counteracted by the support member. Therefore, the deformation of the liquid crystal panel 5 provided on the frame 6 can be effectively reduced so that light leakage can be prevented. In the embodiment, the number of the support member can be more than one, such as shown in FIG. 7. Alternatively, the number of the support member can be one. In addition, other optical films can also be provided above the prism film, such as a protection film for protecting the prism film, a diffusing film for improving the optical efficiency, etc., depending on design requirements. The positions and the number of those optical films can be adjusted as necessary.

According to the embodiment, the protection film is provided on the prism film and at least one columnar support member is provided on the surface of the protection film. When the liquid crystal panel is subject to a force upon pressing or impact, the force can be counteracted by the columnar support member provided on the protection film, and therefore, the deformation of the liquid crystal panel can be effectively reduced to prevent light leakage.

### Sixth Embodiment

FIG. 8 is a schematic view showing the structure of the backlight module according to a sixth embodiment of the present invention. As shown in FIG. 8, the backlight module 100 can comprise a light source 8 with a prism film 2 and a protection film 1 provided on the surface of the light source 8. The protection film 1 is provided on the upper surface of the prism film 2. A support member 13 having a trapezoid-like shape with a trapezoid-like cross section is provided on the upper surface of the protection film 1, as an tipper portion, for supporting the liquid crystal panel 5. When the liquid crystal panel 5 is subject to a force upon pressing or impact, the force can be counteracted by the support member. Therefore, the deformation of the liquid crystal panel 5 provided on the frame 6 can be effectively reduced so that light leakage can be prevented. In the embodiment, the number of the support member can be one. Alternatively, the number of the support member can be more than one. In addition, other optical films can also be provided above the prism film, such as a protection film for protecting the prism film, a diffusing film for improving the optical efficiency, etc., depending on design requirements. The positions and the number of those optical films can be adjusted as necessary.

According to the embodiments of the present invention, when the liquid crystal panel is subject to a force upon pressing or impact, the force can be counteracted by the support member, and therefore, the deformation of the liquid crystal panel can be effectively reduced to prevent light leakage.

The invention being thus described, it will be obvious that the same may be varied in many ways. For example, a plurality of support members with different shapes can be applied to the LCD panel. Such variations are not to be regarded as a departure from the spirit and scope of the invention, and all such modifications as would be obvious to those skilled in the art are intended to be included within the scope of the following claims.

What is claimed is:

1. A backlight module including a light source, wherein at least one support member formed on an upper portion of an optical film is provided on the upper surface of the light source for supporting a liquid crystal panel.

2. The backlight module according to claim 1, wherein the support member has a cross-section selected from the group consisting of an arc-shaped body with a higher central portion and two lower ends, a column body and a trapezoid-like body.

3. The backlight module according to claim 1, wherein the optical film is a prism film.

4. The backlight module according to claim 1, wherein the optical film is a protection film.

5. The backlight module according to claim 1, wherein the optical film is a diffusing film.

6. A liquid crystal display, comprising:
a liquid crystal panel;
a light source provided below the liquid crystal panel; and
at least one support member formed on an upper portion of an optical film provided on the upper surface of the light source for supporting the liquid crystal panel.

7. The liquid crystal display according to claim 6, characterizing in that the support member has a cross-section selected from the group consisting of an arc-shaped body with a higher central portion and two lower ends, a column body and a trapezoid-like body.

8. The liquid crystal display according to claim 6, wherein the optical film is a prism film.

9. The liquid crystal display according to claim 6, wherein the optical film is a protection film.

10. The liquid crystal display according to claim 6, wherein the optical film is a diffusing film.
